(19) United States
(12) Patent Application Publication
(10) Pub. No.: US 2011/0018849 A1
(43) Pub. Date: Jan. 27, 2011

(54) SYSTEM, METHOD AND APPARATUS FOR IMBEDDING A DISPLAY IN A BEZEL

(75) Inventors: Kenneth Roy Lowe, San Juan Capistrano, CA (US); Matthew Blake McRae, Laguna Beach, CA (US); John Schindler, Ladera Ranch, CA (US)

Correspondence Address: Documents and Design, LLC, 206 North Derby Lane, North Sioux City, SD, 57049, US

(73) Assignee: VIZIO INC., Irvine, CA (US)

(21) Appl. No.: 12/509,920

(22) Filed: Jul. 27, 2009

(51) Int. Cl. G09G 5/00; G09G 3/14; G09G 3/18

(52) U.S. Cl. 345/205; 345/46; 345/50

(57) ABSTRACT

An application for a bezel with an internal graphics display system. The display system arranged to display static, dynamic or moving graphical images. The graphics display system consists of a bezel face and a display element. The bezel face is constructed of a transparent or translucent material such that light transmitted by the display element located behind the bezel face passes through the bezel face to the outside. The display element receives graphic images from a processing element and displays the image.

### CROSS-REFERENCE TO RELATED APPLICATION

This application is related to U.S. application titled, “SYSTEM, METHOD AND APPARATUS FOR ILLUMINATING A BEZEL,” which was filed on even date herewith; attorney docket number 80519 and inventors Kenneth Lowe, Matthew Blake McRae and John Schindler.

### FIELD OF THE INVENTION

This invention relates to the field of display devices and more particularly to a system for providing a display device within the bezel of a monitor/television.

### BACKGROUND OF THE INVENTION

Monitor/television devices such as LCD or Plasma televisions have a bezel surrounding the actual display device (LCD panel, Plasma panel, CRT, etc). There have been many colors and varieties of bezels. Most bezels on current monitor/television products are black, while bezels on notebook computers and monitors are often colored to match the color of the shell of the notebook computer or monitor, sometimes white, black, dark blue, etc.

There are many reasons for different bezel appearances. Some bezels reflect a trade dress of the manufacturer of the monitor/television, often having an embossed logo. Some bezels include a lighted word, usually the manufacturer's name such as, “Vizio.” Some bezels are colored to coordinate, or at least, not clash with their environment. For this reason, many current television manufacturers select a black color for their bezels, since black goes with many different environments.

Another reason for different colored bezels is to reduce distraction away from the viewed picture, movie, text, etc. In some cases, a strongly contrasting bezel may lead to eye strain. This contrast issue is difficult to address with a fixed-color bezel, since it is difficult to predict what will be displayed in the display area of the monitor/television. For example, a light-colored bezel would blend well with text displayed on a white page but would not blend well with a movie, especially during scenes that are dark. Likewise, a dark or black colored bezel would blend well with the movie but would be distracting when viewing, for example, text on a white page.

One solution is to provide a monitor or television with interchangeable bezels so that the end user is able to select a bezel from a limited set of colors such as black, white and silver. This helps blend the bezel with the environment, for example when the monitor/television is used in a modern-styled home with predominately white colors, the standard black bezel can be exchanged or covered with a white bezel. This solution does not provide for varying the bezel color/appearance with respect to variations of the displayed subject matter and does not solve the problem of a varying environment such as daytime vs. nighttime viewing. Furthermore, this solution is limited to a small set of bezel colors.

In days past, the bezel of a television often supported controls such as channel and volume. In essence, the bezel of a television or monitor is wasted space and represents an area of the television or monitor that serves little function.

What is needed is a bezel that changes color and/or displays information based upon user direction to match the environment and/or displayed content.

### SUMMARY

The present invention includes a bezel with internal graphic capabilities such that, the brightness, color and content appearing on the bezel are presented based upon user preference and/or internal parameters such as time, content being viewed, internal or external information, meta data sources, etc.

In one embodiment, a graphics display system mounted on a monitor/television is disclosed including a bezel mounted on a periphery of a face of the monitor/television. The bezel surrounds a display panel and is made of a material capable of transmitting light from within the bezel to outside of the bezel (e.g., transparent or translucent). At least one graphics display element is situated behind the bezel. The graphics display elements are situated such that when any of the graphics display elements is energized to display information, the information is visible through the bezel.

In another embodiment, a method of controlling one or more graphics display elements within a monitor/television bezel is disclosed including providing the graphics display elements mounted behind a bezel of a monitor/television. The graphics display elements mounted on a periphery of a face of the bezel whereas the bezel surrounds a display panel and is made from a material capable of transmitting light from the graphics display elements to outside of the bezel. The method continues with providing a processing element interfaced to each of the one or more graphics display elements and which causes the one or more graphics display elements to display data.

In another embodiment, a graphics bezel mounted on a periphery of a face of a monitor/television is disclosed including a bezel mounted on a periphery of a face of the monitor/television, the bezel surrounding a display panel, the bezel made of a material, the material transmitting light from within the bezel to outside of the bezel and at least one graphics display element situated behind a face of the bezel. The graphics display elements situated such that when data is displayed on any of the graphics display elements, the data is visible through the bezel.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a monitor/television with a bezel of the present invention.

FIG. 2 illustrates a second plan view of a monitor/television with a bezel of the present invention.

FIG. 3 illustrates a third plan view of a monitor/television with a bezel of the present invention.

FIG. 4 illustrates a fourth plan view of a monitor/television with a bezel of the present invention.

FIG. 4A illustrates a fifth plan view of a monitor/television with a bezel of the present invention.

FIG. 5 illustrates a cross-sectional view lengthwise of a typical bezel of the present invention.

FIG. 6 illustrates a cross-sectional view side-wise of a typical bezel of the present invention.

FIG. 7 illustrates a first schematic view of a typical monitor/television of the present invention.

FIG. 7A illustrates a second schematic view of a typical monitor/television of the present invention.

FIG. 8 illustrates a first flow chart of the present invention.

FIG. 9 illustrates a second flow chart of the present invention.

FIG. 10 illustrates a plan view of a first typical on-screen display of the present invention.

FIG. 11 illustrates a plan view of a second typical on-screen display of the present invention.

FIG. 12 illustrates a plan view of a third typical on-screen display of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. The bezel of the present invention is the facing surface surrounding an image producing surface such as an LCD panel, CRT, Plasma panel, OLED panel and the like.

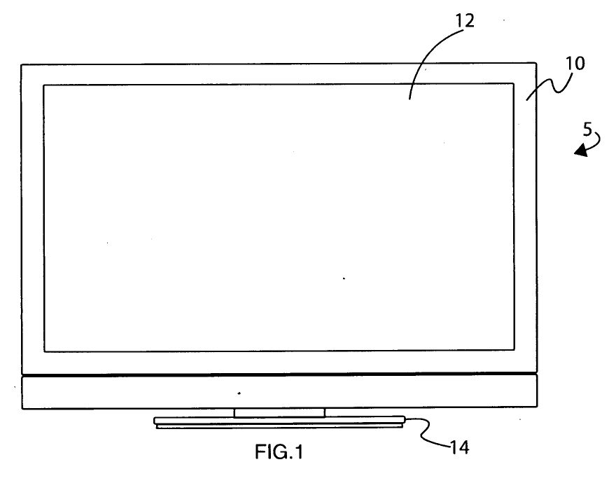

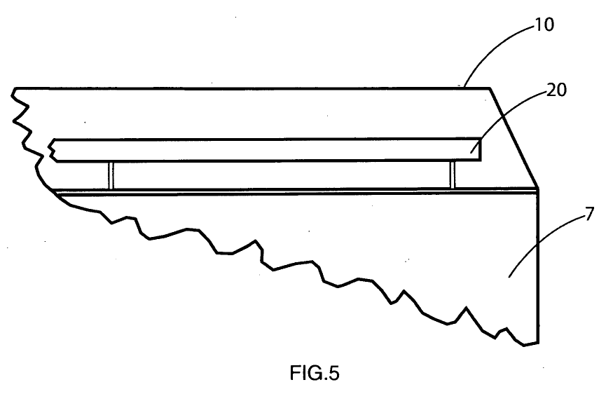

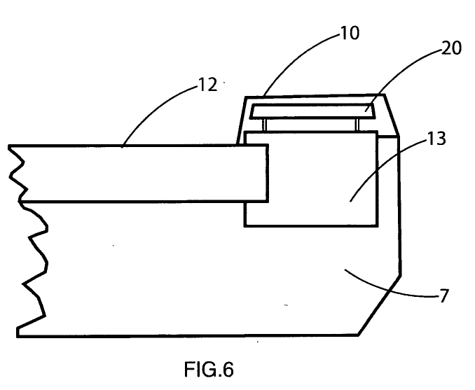

Referring to FIG. 1, a plan view of a monitor/television 5 with bezel 10 of the present invention will be described. The present invention is applicable to any display device that has a bezel such as a monitor/television 5. Typically, the bezel 10 is situated around the peripheral edge of the display panel 12, covering the frame and electronics 13 of the display panel 12 (see FIG. 6). For completeness, though not required in the present invention, the monitor/television is shown on a stand 14. In this view, the bezel 10 is of a first, solid color as a result of a first specific pattern displayed on the bezel display 20 (see FIGS. 5-7).

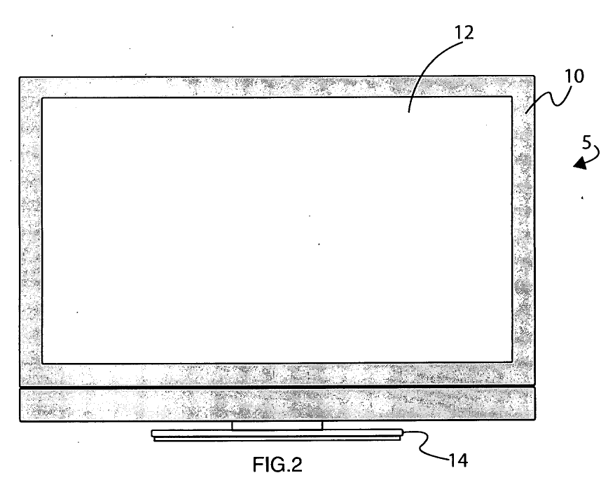

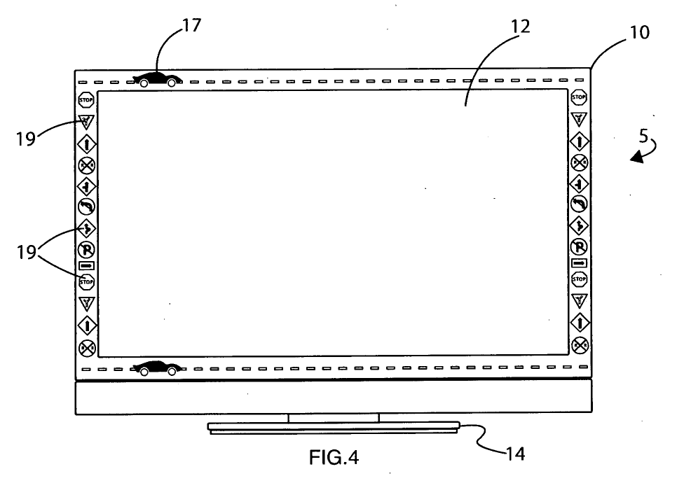

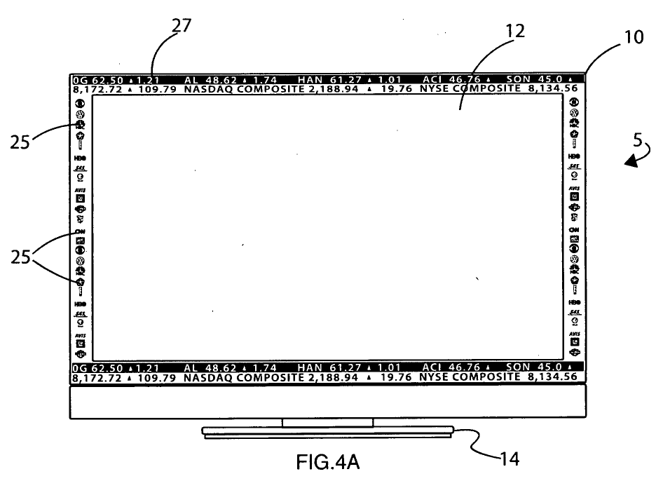

Referring to FIG. 2, a second plan view of a monitor/television 5 with bezel 10 of the present invention will be described. The present invention is applicable to any display device that has a bezel such as a monitor/television 5. Typically, the bezel 10 is situated around the peripheral edge of the display panel 12, covering the frame and electronics 13 (see FIG. 4) of the display panel 12. Again, for completeness, though not required in the present invention, the monitor/television is shown on a stand 14. In this view, the bezel 10 is of a second, solid color as a result of a second specific pattern displayed on the bezel display 20 (see FIGS. 5-7).

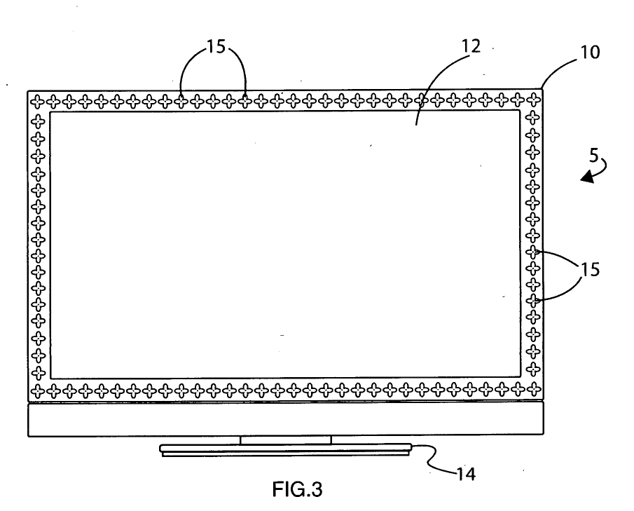

Referring to FIG. 3, a second plan view of a monitor/television 5 with bezel 10 of the present invention will be described. The present invention is applicable to any display device that has a bezel such as a monitor/television 5. Typically, the bezel 10 is situated around the peripheral edge of the display panel 12, covering the frame and electronics 13 (see FIG. 4) of the display panel 12. Again, for completeness, though not required in the present invention, the monitor/television is shown on a stand 14. In this view, the bezel 10 is displaying a static pattern 15 as a result of a third specific pattern displayed on the bezel display 20 (see FIGS. 5-7).

Referring to FIG. 4, a second plan view of a monitor/television 5 with bezel 10 of the present invention will be described. The present invention is applicable to any display device that has a bezel such as a monitor/television 5. Typically, the bezel 10 is situated around the peripheral edge of the display panel 12, covering the frame and electronics 13 (see FIG. 4) of the display panel 12. Again, for completeness, though not required in the present invention, the monitor/television is shown on a stand 14. In this view, the bezel display 20 (see FIGS. 5-7) is displaying an ornamental display consisting of static elements 19 and moving elements 17 (e.g., a car displayed on a road moving from left to right).

Referring to FIG. 4A, a second plan view of a monitor/television 5 with bezel 10 of the present invention will be described. The present invention is applicable to any display device that has a bezel such as a monitor/television 5. Typically, the bezel 10 is situated around the peripheral edge of the display panel 12, covering the frame and electronics 13 (see FIG. 4) of the display panel 12. Again, for completeness, though not required in the present invention, the monitor/television is shown on a stand 14. In this view, the bezel display 20 (see FIGS. 5-7) is displaying information and data important to the user consisting of static elements 25 and moving elements 27 (e.g., the static elements 25 are company logos of stock owned by the user and the dynamic elements 27 are the current stock price of those stocks retrieved from, for example, a network source).

Referring to FIG. 5, a cross-sectional view lengthwise of a typical bezel 10 of the present invention will be described. In this view, the top edge of the bezel 10 is visible as well as a surface 7 of the back housing of the monitor/display. Beneath or within the bezel 10 is a graphics display 20 or multiple graphics displays 20. Such graphics displays 20 are known in the art and include display devices such as light Liquid Crystal Displays (LCD), plasma displays, OLED displays, electronic paper, Light Emitting Diode (LED) arrays, etc. The graphics displays 20 are arranged within one or more area of the bezel 10. For example, in one embodiment, graphics displays 20 are arranged in all four face sections of the bezel 10 (two horizontal and two vertical) while in another embodiment, a graphics display 20 extends the full length of only one of the four face sections of the bezel 10 (e.g., the bottom, horizontal face section) and the other three face section of the bezel 10 are either left empty or include illuminating elements (see related patent). In another embodiment, a graphics display 20 extends partially within only one of the four face sections of the bezel 10 (e.g., the bottom, horizontal face section). The present invention is not limited to any particular configuration of graphic display 20 within the bezel 10 with respect to the number, the size, the shape or coverage of the graphics displays 20.

Referring to FIG. 6, a cross-sectional view side-wise of a typical bezel of the present invention will be described. In this view, the top edge of the bezel 10 is visible as well as a surface 7 of the back housing of the monitor/display. In current practice, the bezel covers the display panel frame 13 and as little of the active display area of the display panel 12 as possible.

Beneath or within the bezel 10 is a graphics display 20 or multiple graphics displays 20. Such graphics displays 20 are known in the art and include display devices such as light Liquid Crystal Displays (LCD), plasma displays, OLED displays, electronic paper, Light Emitting Diode (LED) arrays, etc. The graphics displays 20 are arranged within one or more area of the bezel 10. For example, in one embodiment, graphics displays 20 are arranged in all four face sections of the bezel 10 (two horizontal and two vertical) while in another embodiment, a graphics display 20 extends the full length of only one of the four face sections of the bezel 10 (e.g., the bottom, horizontal face section) and the other three face section of the bezel 10 are either left empty or include illuminating elements (see related patent). In another embodiment, a graphics display 20 extends partially within only one of the four face sections of the bezel 10 (e.g., the bottom, horizontal face section). The present invention is not limited to any particular configuration of graphic display 20 within the bezel 10 with respect to the number, the size, the shape or coverage of the graphics displays 20.

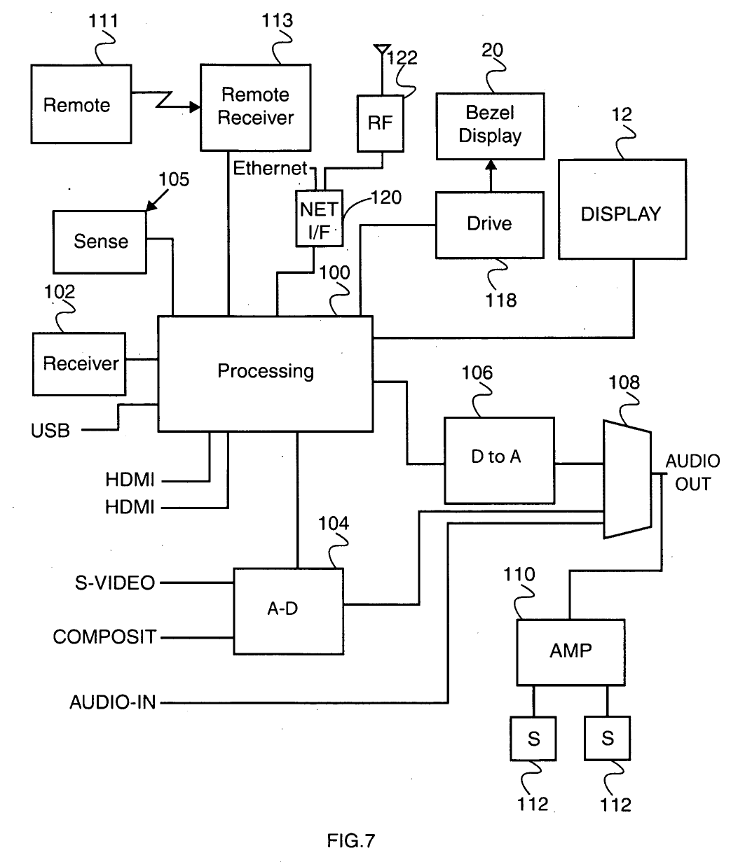

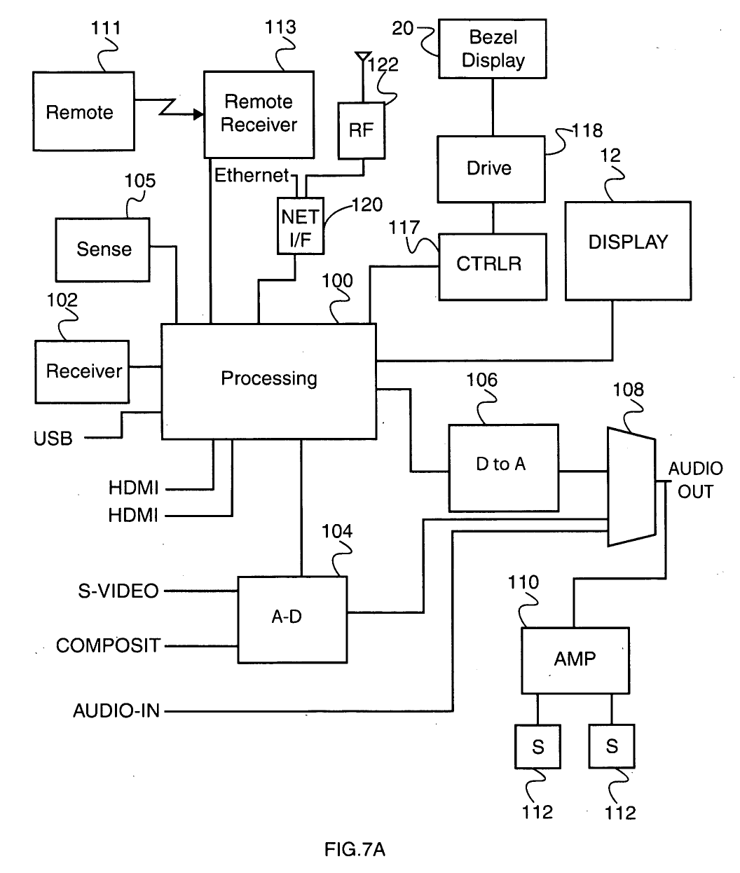

Referring to FIG. 7, a first schematic view of a typical monitor/television of the present invention will be described. This figure is intended as a representative schematic of a typical monitor/television 5 and in practice, some elements are not present in some monitors/televisions 5 and/or additional elements are present in some monitors/televisions 5. In this example, a display panel 12 is connected to a processing element 100. The display panel 12 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High-definition Media Inputs (HDMI), USB ports and an analog-to-digital converter 104. The analog-to-digital converter 104 accepts analog inputs from legacy video sources such as S-Video and Composite video and converts the analog video signal into a digital video signal before passing it to the processing element. The processing element controls the display of the video on the display panel 12.

Audio emanates from either the broadcast receiver 102, the legacy source (e.g., S-Video) or a discrete analog audio input (Audio-IN). If the audio source is digital, the processing element 100 routes the audio to a digital-to-analog converter 106 and then to an input of a multiplexer 108. The multiplexer 108, under control of the processing element 100, selects one of the audio sources and routes the selected audio to the audio output and an internal audio amplifier 110. The internal audio amplifier 110 amplifies the audio and delivers it to internal speakers 112/114.

The processing element 100 accepts commands from a remote control 111 through remote receiver 113. Although IR is often used to communicate commands from the remote control 111 to the remote receiver 113, any known wireless technology is anticipated for connecting the remote control 111 to the processing element 100 including, but not limited to, radio frequencies (e.g., Bluetooth), sound (e.g., ultrasonic) and other spectrums of light. Furthermore, it is anticipated that the wireless technology be either one way from the remote 111 to the receiver 113 or two way.

In some embodiments, a light sensor 105 is interfaced to the processing element 100, for example, a photodiode. The light sensor 105 conveys a value representing the ambient light level in the vicinity of the front of the monitor/television 5. This value is used, for example, to vary the brightness of the display 12 and/or the graphic display(s) 20 responsive to the ambient light present in front of the monitor/television 5.

The processing element 100 further controls the bezel display 20 through a bezel driver 118. In this, serial or parallel outputs from the processing element 100 interface with a graphics display driver 118 which is connected to and controls the graphics display(s) 20. It is well known in the industry how to display an image on a graphics display 20 and this is but an example of such. In some embodiments, the functionality of the bezel driver 118 is integrated into the processing element 100. In some embodiments, the drivers 118 are integrated into the bezel display 20. Any other known configuration is anticipated and functions within the present invention. It is well known how to control Liquid Crystal Displays (LCD), plasma displays, OLED displays, electronic paper, Light Emitting Diode (LED) arrays, etc. For example, in embodiments where the bezel display 20 comprises an array of LEDS, the bezel driver 118, in one embodiment, the bezel driver 118 uses pulse-width modulation to control the brightness or each group of LEDS (e.g., the wider the pulse width, the brighter that group of LEDS will shine). Alternately, in another embodiment, the bezel driver 118 controls the current flowing through the group of LEDS to control the brightness or each that group.

In some embodiments, the television/monitor 5 is connected to a network, such as the Internet or local area network. In these embodiments, a network interface 120 monitors the network and transfers data back and fourth between the processing element 100 and the network. In some embodiments, the network is a wired network such as an Ethernet network. In other embodiments, the network is wireless such as WiFi/802.11 and a wireless interface 122 is provided.

Referring to FIG. 7A, a second schematic view of a typical monitor/television of the present invention will be described. This figure is intended as another representative schematic of a typical monitor/television 5 and in practice, some elements are not present in some monitors/televisions 5 and/or additional elements are present in some monitors/televisions 5. In this example, a display panel 12 is connected to a processing element 100. The display panel 12 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High-definition Media Inputs (HDMI), USB ports and an analog-to-digital converter 104. The analog-to-digital converter 104 accepts analog inputs from legacy video sources such as S-Video and Composite video and converts the analog video signal into a digital video signal before passing it to the processing element. The processing element controls the display of the video on the display panel 12.

Audio emanates from either the broadcast receiver 102, the legacy source (e.g., S-Video) or a discrete analog audio input (Audio-IN). If the audio source is digital, the processing element 100 routes the audio to a digital-to-analog converter 106 and then to an input of a multiplexer 108. The multiplexer 108, under control of the processing element 100, selects one of the audio sources and routes the selected audio to the audio output and an internal audio amplifier 110. The internal audio amplifier 110 amplifies the audio and delivers it to internal speakers 112/114.

The processing element 100 accepts commands from a remote control 111 through remote receiver 113. Although IR is often used to communicate commands from the remote control 111 to the remote receiver 113, any known wireless technology is anticipated for connecting the remote control 111 to the processing element 100 including, but not limited to, radio frequencies (e.g., Bluetooth), sound (e.g., ultrasonic) and other spectrums of light. Furthermore, it is anticipated that the wireless technology be either one way from the remote 111 to the receiver 113 or two way.

In some embodiments, a light sensor 105 is interfaced to the processing element 100. The light sensor 105 conveys a value representing the ambient light level in the vicinity of the front of the monitor/television 5.

In this example, the processing element 100 further controls the bezel display 20 through a controller 117. The controller 117 interfaces either directly to the bezel display 20 or through a bezel driver 118 to the bezel display 20. In this, serial (e.g., I2C) or parallel outputs from the processing element 100 interface with the controller 117 which is connected to and controls the bezel display(s) 20 either through dedicated drivers 118 or directly (not shown). It is well known in the industry how to display an image on a graphics bezel display 20 and this is but an example of such. In some embodiments, the controller 117, bezel drivers 118 and bezel display 20 are powered by auxiliary power (power supplied when the television/monitor 5 is in standby mode). In these embodiments, the controller 117 continues to provide images and colors to the bezel display 20, even when the television/monitor 5 is in auxiliary mode (e.g., appears to be off). In some embodiments, the controller 117 and/or drivers 118 are integrated into the bezel display 20. Any other known configuration is anticipated and functions within the present invention. It is well known how to control Liquid Crystal Displays (LCD), plasma displays, OLED displays, electronic paper, Light Emitting Diode (LED) arrays, etc. For example, in embodiments where the bezel display 20 comprises an array of LEDS, the bezel driver 118, in one embodiment, the bezel driver 118 uses pulse-width modulation to control the brightness or each group of LEDS (e.g., the wider the pulse width, the brighter that group of LEDS will shine). Alternately, in another embodiment, the bezel driver 118 controls the current flowing through the group of LEDS to control the brightness or each that group.

In some embodiments, the television/monitor 5 is connected to a network, such as the Internet or local area network. In these embodiments, a network interface 120 monitors the network and transfers data back and fourth between the processing element 100 and the network. In some embodiments, the network is a wired network such as an Ethernet network. In other embodiments, the network is wireless such as WiFi/802.11 and a wireless interface 122 is provided.

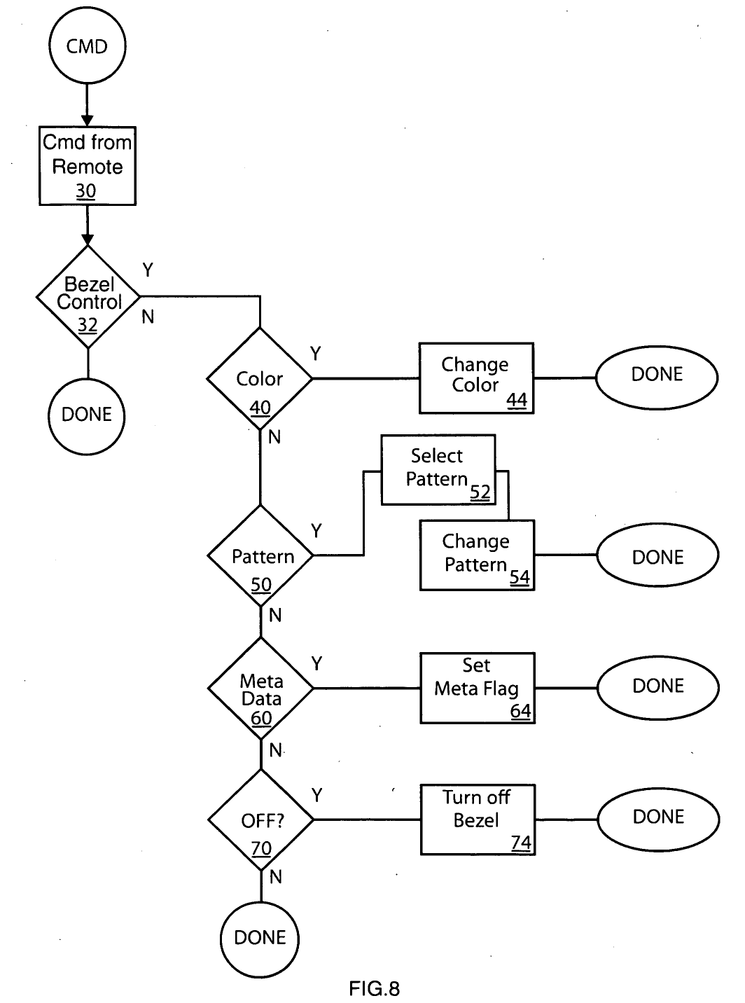

Referring to FIG. 8, a first flow chart of the present invention will be described. This is an exemplary program flow executed within the processing element 100 upon reception of a command 30 from the remote control 111. The command 30 is tested to see if it is a bezel control 32. If not, the existing processing continues as known in the art. If it is, the command 30 is tested to determine if it is a request to change 40 the color of the bezel 10. If it is, in this example, an on screen display is presented to change the color 44. Other methods are also anticipated to effect the color change such as sequencing through a series of colors, etc.

If it isn't a request to change the color 40 of the bezel 10, then the command 30 is tested to determine if it is a request to change the color pattern 50 of the bezel 10. If it is, in this example, an on screen display is presented to change the color pattern 54. Other methods are also anticipated to effect the color change such as sequencing through a series of color patterns, etc.

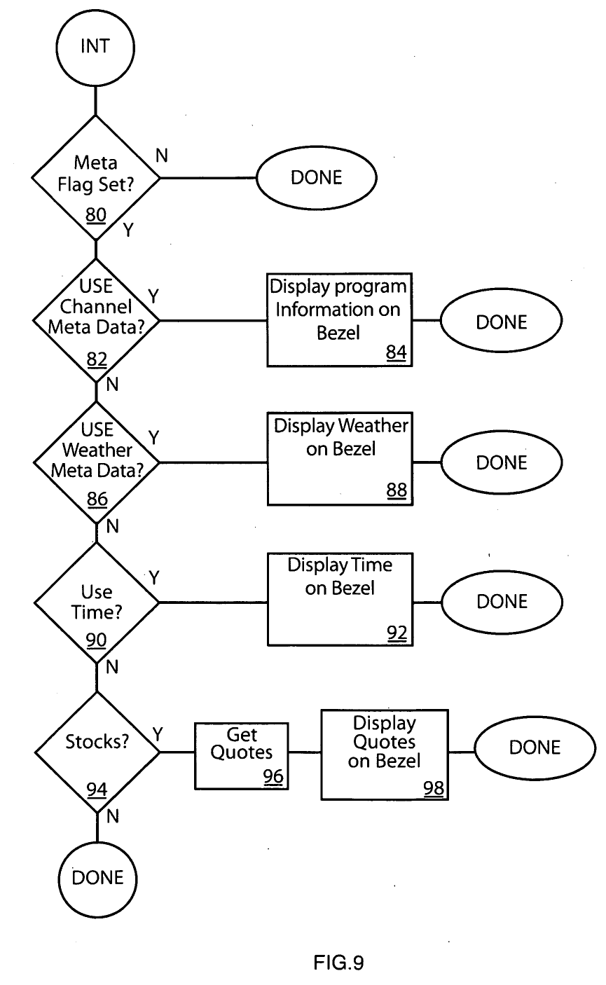

If it isn't a request to change the color pattern of the bezel 50, then the command is tested to determine if it is a request to turn on meta-data 60. If it is, in this example, a meta-data flag is set 64. The use of this flag is described with FIG. 9.

If it isn't a request to use meta-data 60, then the command 30 is tested to determine if it is a request to turn off the bezel 70. If it is, in this example, the bezel is turned off 74. If it isn't a request to turn off the bezel 70, processing continues.

Referring to FIG. 9, a second chart of the present invention will be described. This is an exemplary program flow executed within the processing element 100 periodically (e.g., at fixed intervals or at a particular instance such as during re-trace, etc.). First, the meta-data flag is tested to see if it is enabled 80. If not enabled, the flow is done. If it is enabled 80, the meta-flag is tested 80 to determine which type of meta-data is to be used in controlling the bezel 10 graphics display 10. For example, if the meta-data is set to use the current channel 82, then the graphics display 20 of the bezel 10 is set based on the current channel being used 84. For example, if the Discovery Channel is being watched, then the graphics display 20 of the bezel 10 is set to a pattern or color (e.g., green, trees) and if the Weather Channel is being watched, the graphics display 20 of the bezel 10 is set to a second pattern color (e.g., blue, snowflakes). In this way, the viewer has information regarding which channel is being watched by the content displayed on the graphics display 20 of the bezel 10, even when a commercial is playing.

If the meta-data is not set to use the current channel 82, the meta-flag is then tested 86 to determine if the current outside weather is to be used in controlling the graphics display 20 of the bezel 10. For example, if the meta-data is determined 86 to use the weather, then the information on the graphics display 20 of the bezel 10 is set based on the current weather 88. For example, if internal data or retrieved data (e.g., from the Internet) available to the processing element 100 indicates that it is sunny; the graphics display 20 of the bezel 10 is set to a first pattern and/or color (e.g., yellow or sunshine pattern). If internal data or retrieved data available to the processing element 100 indicates that it is rainy, the graphics display 20 of the bezel 10 is set to display a second pattern and/or color (e.g., gray or cloud pattern). In this way, the viewer has information regarding the weather while watching their favorite program. The graphics display 20 of the bezel 10 is updated each time this flow is executed by the processing element 100 and, therefore, shows current information.

If the meta-data is not set to use the weather 86, the meta-flag is then tested to determine 90 if the current time is to be used in controlling the graphics display 20 of the bezel 10. For example, if the meta-data is determined 90 to use the current time, then the graphics display 20 of the bezel 10 is configured to display the current time 92. This is just an example, time, date/time, etc. or any data available within the monitor/television 5 or externally from connected devices or from a network are anticipated. The graphics display 20 of the bezel 10 is updated each time this flow is executed by the processing element 100 and, therefore, shows current information.

If the meta-data is not set to use the time 90, the meta-flag is then tested to determine 94 if stock quotes are to be presented by controlling the graphics display 20 of the bezel 10. For example, the current stock quotes for the most commonly held stocks or for a list of stocks provided by the user are retrieved 96 from a connected device or from a network. The current stock quotes are then displayed 98 on the graphics display 20 of the bezel 10. This is just an example, time, date/time, etc. or any data available within the monitor/television 5 or externally from connected devices or from a network are anticipated. The graphics display 20 of the bezel 10 is updated each time this flow is executed by the processing element 100 and, therefore, shows current information. In this example, if all of the desired stocks quotes fit within the graphics display 20, all are displayed each time the flow is executed. If all of the desired stocks quotes do not fit within the graphics display 20, a subset of the stock quotes are displayed each time the flow is executed. An example of this would be to emulate a stock quote ticker tape. This description is an example of the many types of data that are anticipated and the present invention is not limited in any way to any particular data or source of data.

Some sources of data are internal to the television/monitor 5 while other sources of data are external. In some embodiments, the external data is derived from broadcast sources (e.g., television channels). In some embodiments, the external source of data is a device connected to the television/monitor 5 such as a set-top box, etc. In still other embodiments, the external source of data is another device within the household (e.g., personal computer, wireless thermometer, etc.) connected to the television/monitor 5 through a network, either wired or wireless. Still other embodiments include data from external sources obtained by the television over a network such as the Internet. Some further examples of data include, but is not limited to, traffic congestion, airline delays, delivery status, restaurant queue delays, schedules, commodity prices, mortgage rates, CD rates, other financial information, temperatures/weather in other cities, home computer status, location of children/parents, activities of children/parents, instant messages, incoming caller id, television control prompts/instructions, current channel, current program information, alternate channel program information, weather alerts, news alerts, smog alerts, etc. are all anticipated as well as channel, program guide info, chat sessions, twitter, etc.

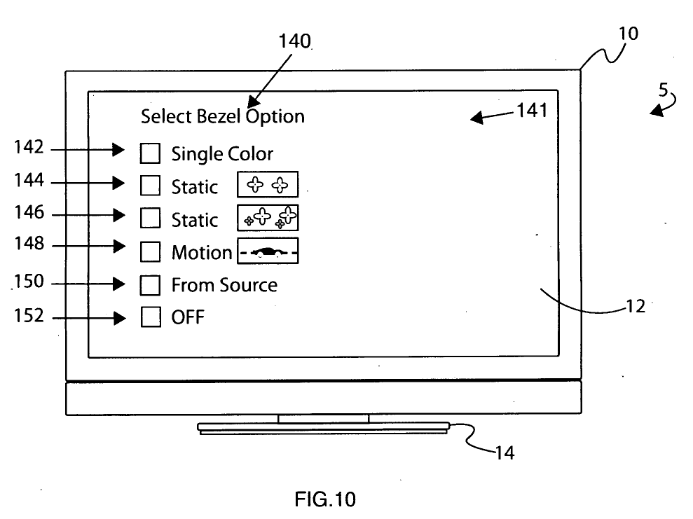

Referring to FIG. 10, a plan view of a first typical on-screen display of the present invention will be described. Many user interfaces are known in the industry and the option selection user interface of FIG. 10 is but one example. In this example, the user is presented with the heading “Select Bezel Option” 140 along with a list of possible selections 141. In the list of possible selections 141 are “display a single color” 142, “display a first static pattern” 144 (similar to FIG. 3), “display a second static pattern” 146, “display a motion pattern” 148 (similar to FIG. 4), “display from a source” 150 and “off” 152. In this user interface, it is anticipated to have more or less selections, as determined by the user and/or monitor/television manufacturer and/or data available (e.g., if a connection to the Internet is unavailable, no option is presented to display stock quotations).

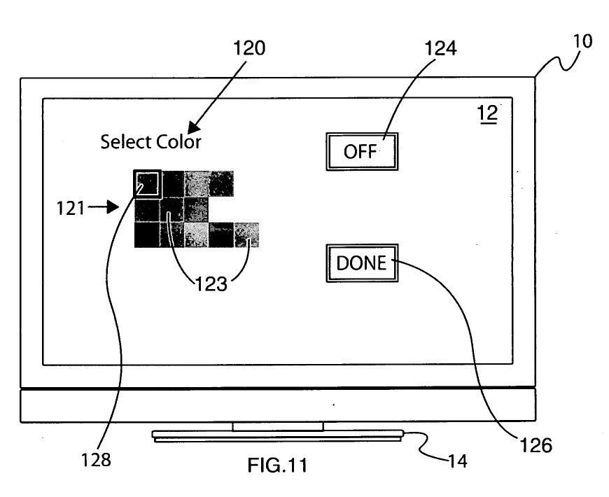

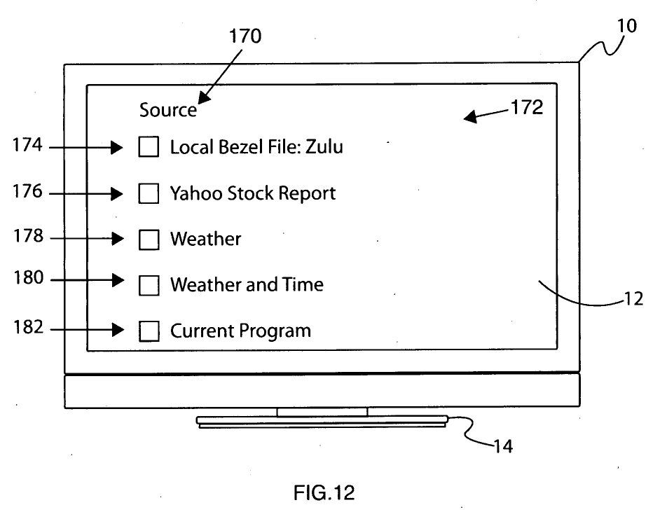

In response to the user selecting a single color 142, a color choice on-screen display is displayed on the display panel 12 as shown in FIG. 11. In response to the user selecting a static pattern 144/146, the selected static display is displayed on the graphics display 20 within the bezel 10. In response to the user selecting a motion pattern 148, the motion pattern is displayed on the graphics display 20 within the bezel 10. In response to the user selecting a data source 150, a data source user interface is displayed on the display panel 12 as shown in FIG. 12. In response to the user selecting “off,” 152 the graphics display 20 within the bezel 10 is shut off.

Referring to FIG. 11, a plan view of a first typical on-screen display of the present invention will be described. Many user interfaces are known in the industry and the color selection user interface of FIG. 8 is but one example. In this, the user is presented with a heading “Select Color” 120 along with a grid of possible colors 121. In the grid of possible colors 121 are multiple color choices 123, one of which is highlighted 122. Using an input device, such as a television remote control 111, the user/viewer maneuvers the highlighting 122 to the color choice desired, and then selects the “DONE” feature 126. Responsive to the “DONE” feature 126 being activated, the bezel is changed to the selected color. If, instead, the user/viewer wishes to turn off the bezel color, the user/viewer selects the “OFF” feature 124 and the bezel illumination is turned off.

Referring to FIG. 12, a plan view of a third typical on-screen display of the present invention will be described. Many user interfaces are known in the industry and the meta-data selection user interface of FIG. 12 is but one example. In this example, the user is presented with a heading “Select Source:” 170 along with several choices 172. The user/viewer maneuvers to the desired choice 172 using an input device such as the arrow keys on a television remote control 111. Once at the desired choice 172, the user/viewer selects that choice using, perhaps, whereby the processing element 100 sets up the graphics display 20 within the bezel 10 accordingly. For example, if “Local Bezel File: zulu” 174 is selected, the contents of the file zulu is displayed on the graphics display 20 within the bezel 10. If “Yahoo Stock Report” 176 is selected, the user's favorite stock quotes are retrieved from Yahoo and are displayed on the graphics display 20 within the bezel 10 (and refreshed periodically). If “Weather” 178 is selected, the current weather is retrieved from the Internet and is displayed on the graphics display 20 within the bezel 10 (and refreshed periodically). If “Weather and Time” 180 is selected, the current weather is retrieved from the Internet and is displayed (and refreshed periodically) on the graphics display 20 within the bezel 10 along with the current time which is maintained internally to the monitor/television 5 (and refreshed periodically). If “Current Program” 182 is selected, information regarding the current program is retrieved, for example from the Internet or a local electronic program guide (EPG) and is displayed on the graphics display 20 within the bezel 10.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A bezel graphics display system mounted on a monitor/television, the bezel graphics display system comprising:
a bezel mounted on a periphery of a face of the monitor/television, the bezel surrounding a display panel, the bezel made of a material, the material transmitting light from within the bezel to outside of the bezel; and
at least one graphics display element situated behind the bezel, the at least one graphics display element situated such that when any of the at least one graphics display elements is energized to display information, the information is visible through the bezel.

2. The graphics display system of claim 1, wherein each of the graphics displays is selected from the group consisting of an LCD panel, an array of light emitting diodes, electronic paper and an organic light emitting diode panel.

3. The graphics display system of claim 1, wherein a static image is displayed on each of the graphics display elements.

4. The graphics display system of claim 1, wherein an image is displayed on each of the graphics display elements is periodically changed.

5. The graphics display system of claim 1, wherein a motion image is displayed on each of the graphics display elements.

6. The graphics display system of claim 1, wherein data is retrieved from a network and displayed on each of the graphics display elements.

7. The graphics display system of claim 1, wherein data internal to the monitor/television is displayed on each of the graphics display elements.

8. A method of controlling one or more graphics display elements within a monitor/television bezel, the method comprising:
providing the one or more graphics display elements mounted behind a bezel of a monitor/television, the one or more graphics display elements mounted on a periphery of a face of the bezel of the monitor/television, the bezel surrounding a display panel, the bezel made of a material, the material transmitting light from the one or more graphics display elements to outside of the bezel;
providing a processing element interfaced to each of the one or more graphics display elements; and
causing, by the processing element, the one or more graphics display elements to display data.

9. The method of claim 8, wherein each of the one or more graphics display elements is selected from the group consisting of an LCD panel, an array of light emitting diodes, electronic paper and an organic light emitting diode panel.

10. The method of claim 8, further comprising a step of deriving the data from information available within the monitor/television before the step of causing.

11. The method of claim 8, further comprising a step of retrieving the data from outside of the monitor/television before the step of causing.

12. The method of claim 11, further comprising a step of retrieving the data from an Internet before the step of causing.

13. The method of claim 11, further comprising a step of retrieving the data from a connected device before the step of causing.

14. The method of claim 12, wherein the data is selected from the group consisting of a current time, a date, weather, stock quotations, traffic congestion, airline delays, delivery status, restaurant queue delays, schedules, commodity prices, mortgage rates, CD rates, other financial information, temperatures/weather in other cities, home computer status, location of children/parents, activities of children/parents, instant messages, incoming caller id, television control prompts/instructions, current channel, current program information, alternate channel program information, weather alerts, news alerts and smog alerts.

15. A graphics bezel mounted on a periphery of a face of a monitor/television, the graphics bezel comprising:
a bezel mounted on a periphery of a face of the monitor/television, the bezel surrounding a display panel, the bezel made of a material, the material transmitting light from within the bezel to outside of the bezel;
at least one graphics display element situated behind a face of the bezel, the at least one graphics display element situated such that when data is displayed on any of the at least one graphics display elements, the data is visible through the bezel.

16. The graphics bezel of claim 15, further comprising a processing element disposed within the monitor/television, the processing element controlling the data being displayed on each of the graphics display elements.

17. The graphics bezel of claim 15, wherein each of the at least one graphics display elements is selected from the group consisting of an LCD panel, an array of light emitting diodes, electronic paper and an organic light emitting diode panel.

18. The graphics bezel of claim 16, wherein the data is retrieved by the processing element from a connected device.

19. The graphics bezel of claim 16, wherein the data is retrieved by the processing element from a network.

20. The graphics bezel of claim 15, wherein the data is selected from the group consisting of a current time, a date, weather, stock quotations, traffic congestion, airline delays, delivery status, restaurant queue delays, schedules, commodity prices, mortgage rates, CD rates, other financial information, temperatures/weather in other cities, home computer status, location of children/parents, activities of children/parents, instant messages, incoming caller id, television control prompts/instructions, current channel, current program information, alternate channel program information, weather alerts, news alerts and smog alerts.
